(19) United States
(12) Patent Application Publication
(10) Pub. No.: US 2026/0050618 A1
(43) Pub. Date: Feb. 19, 2026

(54) LARGE LANGUAGE MODEL ON PLATFORM DATA

(71) Applicant: VIDEOAMP, INC., Los Angeles, CA (US)

(72) Inventors: Suzanne Elizabeth Willard, Bend, OR (US); Makoto Uchida, Mountain View, CA (US); Grant Kushida, Sherman Oaks, CA (US); Christopher Gutierrez, Ranchos De Taos, NM (US); Bruno Stefeno, New York, NY (US)

(73) Assignee: VIDEOAMP, INC., Los Angeles, CA (US)

(21) Appl. No.: 19/303,331

(22) Filed: Aug. 18, 2025

Related U.S. Application Data
(60) Provisional application No. 63/684,317, filed on Aug. 16, 2024.
(60) Provisional application No. 63/684,314, filed on Aug. 16, 2024.

(51) Int. Cl. G06F 16/3329; G06F 16/383

(52) U.S. Cl. CPC G06F 16/3329; G06F 16/383

(57) ABSTRACT

A method may include obtaining a platform data set. The method may also include providing a user interface operable to interact with the platform data set. The method may further include obtaining a natural language question from the user interface. The method may also include extracting at least one component from the natural language question. The method may further include identifying a first primitive and a second primitive. The method may also include transforming the natural language question into the tool query based on the at least one component using the first primitive. The method may further include executing the tool query in the tool using the second primitive to obtain query results from the platform data set associated with the natural language question. The method may also include providing the query results to the user interface in a natural language format.

### CROSS REFERENCE TO RELATED APPLICATIONS

This U.S. Patent application claims priority to U.S. Provisional Patent Application No. 63/684,317, titled “LARGE LANGUAGE MODEL ON CONTENT DATA,” and filed on Aug. 16, 2024, and U.S. Provisional Patent Application No. 63/684,314, titled “GENERATIVE ARTIFICIAL INTELLIGENCE FOR AUDIENCE, MEASUREMENT & PLANNING,” and filed on Aug. 16, 2024, the disclosure of which are hereby incorporated by reference in their entirety.

### TECHNICAL FIELD

This disclosure relates to improved data interaction, and more specifically, to creating and implementing a large language model and/or generative artificial intelligence on platform data.

### BACKGROUND

Unless otherwise indicated herein, the materials described herein are not prior art to the claims in the present application and are not admitted to be prior art by inclusion in this section.

A large language model (LLM) is a computational model notable for its ability to achieve general-purpose language generation and other natural language processing tasks, such as classification. Based on language models, LLMs acquire various abilities by learning statistical relationships from vast amounts of text during a computationally intensive self-supervised and semi-supervised training process. LLMs can be used for text generation, a form of generative artificial intelligence (AI), by taking an input text and repeatedly predicting the next token or word. Generative AI (GenAI, or GAI) is artificial intelligence capable of generating text, images, videos, or other data using generative models, often in response to prompts. Generative AI models learn the patterns and structure of their input training data and then generate new data that has similar characteristics.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining a platform data set. The method may also include providing a user interface operable to interact with the platform data set. The method may further include obtaining a natural language question from the user interface. The natural language question may be operable to request a portion of the platform data set. The method may also include extracting at least one component from the natural language question. The method may further include identifying a first primitive operable to transform the natural language question into a tool query associated with a tool configured to obtain information from the platform data set. The method may also include identifying a second primitive operable to execute the tool query in the tool with respect to the platform data set. The method may further include transforming the natural language question into the tool query based on the at least one component using the first primitive. The method may also include executing the tool query in the tool using the second primitive to obtain query results from the platform data set associated with the natural language question. The method may further include providing the query results to the user interface in a natural language format.

In another embodiment, a system may include one or more non-transitory computer-readable storage media configured to store instructions. The system may also include one or more processors communicatively coupled to the one or more non-transitory computer-readable storage media and configured to, in response to execution of the instructions, cause the system to perform operations. The operations may include obtaining a platform data set. The operations may also include providing a user interface operable to interact with the platform data set. The operations may further include obtaining a natural language question from the user interface. The natural language question may be operable to request a portion of the platform data set. The operations may also include extracting at least one component from the natural language question. The operations may further include identifying a first primitive operable to transform the natural language question into a tool query associated with a tool configured to obtain information from the platform data set. The operations may also include identifying a second primitive operable to execute the tool query in the tool with respect to the platform data set. The operations may further include transforming the natural language question into the tool query based on the at least one component using the first primitive. The operations may also include executing the tool query in the tool using the second primitive to obtain query results from the platform data set associated with the natural language question. The operations may further include providing the query results to the user interface in a natural language format.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for utilizing a large language model on platform data;

FIG. 2 illustrates a block diagram of an example flow for evaluating and improving a question utilized in a system illustrated in FIG. 1;

FIG. 3 illustrates a flowchart of an example method for utilizing a large language model on platform data; and

FIG. 4 illustrates an example computing device.

### DETAILED DESCRIPTION

Media measurement and/or analysis associated with digital advertisement and/or digital content distribution may be associated with analyzing big data. Big data may include massive data sets that may be aggregated from multiple data providers, such that obtaining desired information from the big data may be difficult and/or obscured. Further, interactions with the big data may be difficult as the big data may be stored in proprietary formats, or may only recognize specific commands to return requested information. In such instances, persons seeking information from the big data may not be equipped to extract the particular information that they are seeking without one or more intermediate tools or helps in the process.

Aspects of the present disclosure describe a system and method operable to receive questions in a natural language format and automatically perform operations needed to obtain query results from the platform data set. Alternatively, or additionally, aspects of the present disclosure may include implementing generative AI to improve the process and/or improve the results obtained from the platform data set, all while accepting questions from a user in a natural language format.

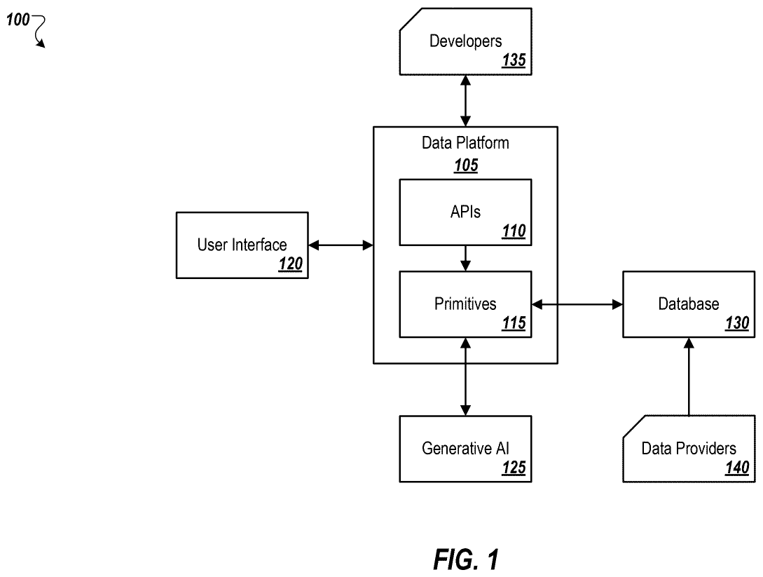

FIG. 1 illustrates a block diagram of an example system 100 for utilizing a large language model on platform data. The system 100 may include a data platform 105, a user interface 120, a generative artificial intelligence (AI) 125, and a database 130. The data platform 105 may include one or more application programming interfaces (APIs) 110, and one or more primitives 115. As described herein, platform data may refer to any type of data that may be obtained and/or utilized by the data platform 105 and/or other components in the system 100. The platform data may include, but not be limited to, content data, advertising measurement data, campaign data, outcome measurement data, audience data, and/or planning data.

In some instances, the system 100 may utilize a large language model (LLM) to facilitate interactions between a user (e.g., via the user interface 120) and a data set stored in the database 130 and/or accessible by the data platform 105. Alternatively, or additionally, the system 100 may utilize the generative AI 125 to facilitate improvements to the interactions between the user and the data set. For example, the system 100 may facilitate content creation, data augmentation, personalization, creative assistance, simulation and modeling, chatbots and virtual assistants, language translation, and/or summarization for a user interacting with the data set included in the database 130. A request from a user for information associated with the data set in the database 130 may vary based on attributes associated with the user and/or how the data may be used. For example, a user may include a broadcast client, a syndication client, a cable client, and/or a local TV client and uses of the data may include custom analysis of a limited event (e.g., the Olympics), local market performance data, audience data associated with programming, and/or market specific news and sports data.

In some instances, the user interface 120 may include any system operable to facilitate interactions between a user and the data platform. For example, the user interface 120 may include a browser, a command line interface (CLI), and/or an API. In some instances, the user may provide a question to the data platform 105 via the user interface 120. In some instances, the question may be provided in a natural language format. The user interface 120 and/or the data platform 105 may be operable to store questions obtained from the user associated with a current session and/or any question from the user provided via the user interface 120 (e.g., across multiple sessions). In these and other instances, the natural language question provided to the user interface 120 may be operable to request at least portion of the data set in the database 130, such as a measurement or inference associated with the data set.

In some instances, the data platform 105 may include the APIs 110 that may be interacted with by the user via the user interface 120. In some instances, the APIs 110 may include public APIs and/or internal APIs, which may affect the visibility and/or use thereof. For example, the APIs 110 that may be public may be utilized by the user via the user interface 120 and the APIs 110 that may be internal may be accessible by developers 135 that may support the data platform 105 and/or other components of the system 100. In some instances, the developers 135 may add, modify, and/or remove the primitives 115, may prepare evaluation data sets for utilization in the system 100 (in accordance with the methods described herein), may prepare development prompts to be used in the system 100, and/or may prepare test sets that may be used to test individual components of the system 100 (e.g., a unit test) and/or the functionality of the system 100 (e.g., a system test).

In some instances, the database 130 may be configured to store various data sets that may be obtained from one or more data providers 140. In instances in which there is more than one data provider 140, the database 130 may be operable to combine the data sets into a platform data set. In some instances, the platform data set may include duplicated data and the data platform 105 and/or the database 130 may be operable to deduplicate portions of the data set that may overlap such that the platform data set may have little to no redundancies included therein.

In some instances, the database 130 may be a cleanroom that may be configured to act as a shared data space with restricted access. The cleanroom may refer to an environment where some or all data may be anonymized, aggregated, processed, and/or stored to be made available for measurement, and/or data transformations in a privacy-focused way. For example, the multiple data providers 140 may desire to share their respective data corpora with one another. The data providers 140 may then enter into a contract or agreement to share data. Responsive to receiving a request from the data providers 140 to create or join the cleanroom, the cleanroom may be created and/or used by the data providers 140.

In some instances, the cleanroom may be accessed using one or more of a service account and/or an encryption key. The cleanroom may include some or all of the respective data corpora from both the data providers 140. Access to the cleanroom may be restricted in any manner. In some examples, the access may be restricted using the service account. A service account may refer to a specific account that has been created for the purpose of accessing a particular shared data space. Additionally or alternatively, access to the cleanroom may be restricted using the encryption key. The encryption key, for example, may limit access only to entities (e.g., the data providers 140) that may have entered into a contract with one another, and may be generated using any method of encryption for encrypting data. Further, an encryption key may only provide one-way access to the entities that have access to the key. The data providers 140 that have an encryption key and access to the cleanroom may desire to have additional entities (e.g., other data providers) and their data corpora joined to the cleanroom. In such a scenario, an additional data provider may be provided an encryption key that may grant access to the cleanroom already created for use by the data providers 140. In some instances, the encryption key may be shared after permission is given by the entities (e.g., the data providers 140) that currently have access to the encryption key.

In some instances, the APIs 110 may facilitate communications between the user interface 120 and the primitives 115. In some instances, the generative AI 125 may provide a chatbot or a chatbot application that may interact with the user utilizing the user interface 120. The chatbot managed by the generative AI 125 may be operable to facilitate communications between the user interface 120 and the primitives 115 via the APIs 110. In some instances, the generative AI 125 may include one or more LLM calls, where each of the LLM calls may include different kinds of prompts that may be utilized with the APIs 110 and/or the primitives 115. In some instances, the generative AI 125 may be operable to dynamically orchestrate the LLM calls, which may include anticipating complexity of a natural language question and evolving orchestration logic to handle varying degree of complexity in the natural language question.

In some instances, the primitives 115 may be operable to interact with one or more LLMs that may be utilized in the system 100. Alternatively, or additionally, the generative AI 125 may interact with the primitives 115, such as to direct operations, optimize the functionality, and/or generate feedback associated with operations performed by the primitives 115. In some instances, the primitives 115 may be predefined and/or may be developed by the developers 135. The primitives 115 in the system 100 may include an extract function, a rewrite function, a route function, a text-to-tool function, and/or a tool-to-text function. Other primitives may be added to the primitives 115, and/or the primitives 115 described herein may be modified, which may contribute to the primitives 115 performing the operations described herein.

In some instances, the APIs 110 may obtain a natural language question from the user via the user interface 120 and may transmit the natural language question to the extract function of the primitives 115. The extract function may be operable to extract one or more components from the natural language question. In some instances, the extract function may call an extract LLM and provide the natural language question as an input and receive the components as an output from the extract LLM. In such instances, the extract LLM may be configured to provide a predefined structured output, which may correspond to components associated with the natural language question where individual attributes of the natural language question may include a corresponding component. In some instances, the extract function may be operable to identify components that may include a missing value and/or an invalid value. In such instances, the extract function may replace the identified components (e.g., having a missing and/or invalid value) with a predetermined value, which may be a default value. The extract function may be operable to generate an output where each attribute of the natural language question may be a component. In some instances, the output from the extract function may adhere to a predefined protocol, such as a JavaScript Object Notation (JSON) file type.

In some instances, the rewrite function of the primitives 115 may be operable to obtain the natural language question, the output from the extract function, and/or the stored questions from the data platform 105. The rewrite function may call a rewrite LLM and provide instructions directing the rewrite LLM to rewrite the natural language question using the components extracted by the extract function. The instructions may include a context resolution that may rephrase the natural language question and/or the stored questions using the extracted components to create a primitive-based query. The rewrite function may inject the components extracted from the extract function into the primitive-based query, where the combination thereof may contribute to preserving an intent from the user associated with the natural language question. For example, the primitive-based query may include important aspects of the natural language question and/or the stored questions by the inclusion of the components and/or the consideration of the stored questions relative to the natural language question that might be less pronounced in the output from the extract function. The output from the rewrite function may be the primitive-based query.

In some instances, the route function of the primitives 115 may be operable to obtain the primitive-based query, and direct the primitive-based query to one or more additional primitives, such as the text-to-tool function and/or the tool-to-text function. Alternatively, or additionally, the route function may be operable to orchestrate the routing of any of the inputs and/or outputs from one primitive to another primitive within the system 100.

In some instances, the text-to-tool function of the primitives 115 may obtain the output from the extract function (e.g., the components associated with the natural language question) and the primitive-based query. The text-to-tool function may be operable to transform the components and the primitive-based query into a tool query that may be in a format based on a particular tool that may service the tool query. For example, in instances in which the particular tool is a structured query language (SQL), the tool query may be formatted for use with SQL. Other tool formats may include, but not be limited to, APIs and/or user defined table functions (UDTFs). In some instances, the text-to-tool function may call a text-to-tool LLM and may provide the output from the extract function and the primitive-based query. In return, the text-to-tool LLM may generate a tool query (e.g., an SQL query for an SQL tool), where the tool query may be operable to return a query result to the natural language question using the platform data set in the database 130. Alternatively, or additionally, the text-to-tool LLM may generate one or more reasoning tokens associated with the tool query that may describe the process and/or analysis performed in determining the tool query (e.g., how the tool query may be operable to obtain the query result to the natural language question from the platform data set). In some instances, the text-to-tool function may output the tool query and/or the reasoning tokens.

In some instances, the tool-to-text function of the primitives 115 may obtain the tool query (e.g., from the text-to-tool function) and/or the primitive-based query (e.g., from the rewrite function) and may handle the implementation of the tool query relative to the corresponding tool. As described, the tool may be operable to interact with the platform data set in the database 130 to obtain the query result associated with the natural language question using the tool query and/or the primitive-based query. In some instances, the tool-to-text function may interact with the database 130 to execute the tool query therein, and may obtain the query results from the database 130. The tool-to-text function may call a tool-to-text LLM and provide the tool query, the query results, the reasoning tokens, and/or the primitive-based query. Alternatively, or additionally, the tool-to-text function may provide the tool-to-text LLM instructions to return a response criteria (associated with the natural language question), an answer to the natural language question, and/or an analysis of the answer. In some instances, the tool-to-text LLM may respond to the instructions in a natural language format. Alternatively, or additionally, the tool-to-text function may request the tool-to-text LLM provide the response in the natural language format. In these and other instances, the tool-to-text function may be operable to transmit the results to the user interface 120. The results transmitted to the user interface 120 may include the natural language response (e.g., the response criteria, the answer to the natural language question, and the analysis of the answer) and/or tabular results associated with the natural language response obtained from the database 130.

In some instances, the accuracy of the natural language response may be evaluated. In some instances, the system 100 may be operable to evaluate an accuracy associated with a single natural language question, an accuracy associated with a particular primitive of the primitives 115, and/or an accuracy of the method performed by the system 100, as described herein. Alternatively, or additionally, the evaluation of the respective accuracies may be repeated and/or logged, such that an aggregation of accuracies may be obtained. The aggregation of accuracies may be utilized to obtain extended statistics associated with the system 100, such as an average accuracy based on a particular type of question.

The system 100 may begin the evaluation by obtaining a ground truth file, where the ground truth file may have an input and a corresponding expected output. Depending on the element being evaluated, there may be additional fields that may correspond to the evaluated element. In some instances, the ground truth file may be provided in a JSON Lines (JSONL) format, where a line in the ground truth file may correspond to one JSON blob.

For the evaluation, an output may be generated based on the input of the ground truth file, and an <output, expected output> pair may be obtained, where the expected output may be obtained from the ground truth file. An exact match may be determined, where if the output exactly matches the expected output, the evaluation may return true; otherwise returns false. Alternatively, or additionally, the output and the expected output may be normalized (e.g., remove double spaces, newlines, symbols, etc.), and then compared after the normalization. In such instances, the exact match evaluation may be performed on the normalized output and the normalized expected output where if the normalized output exactly matches the normalized expected output, the evaluation may return true; otherwise returns false. Alternatively, or additionally, the normalized output and the normalized expected output may be compared using a Jaccard similarity, where the percentage of words that may match between the normalized output and the normalized expected output may be counted and the evaluation may return a percentage representative of the percentage of similar words between the normalized output and the normalized expected output.

Alternatively, or additionally, the output and the expected output may be provided to an evaluation LLM with instructions to judge the similarity between the output and the expected output. In some instances, the evaluation LLM may perform a semantic equivalency analysis between the output and the expected output. In some instances, a scale for describing the semantic equivalency may be input to the evaluation LLM (e.g., a scale of one star to five stars, etc.) and/or dynamic context for evaluating the similarities between the output and the expected output may be input to the evaluation LLM. In some instances, the evaluation LLM may return the determined similarity according to the scale provided to the evaluation LLM.

In some instances, for a given output and expected output pair, a JSON similarity score may be determined. The JSON similarity score may be based on objects, keys, and/or values between the output and the expected output pair match. For example, the JSON similarity score may be 1 if the output object and the expected output object are the same. Continuing the example, the JSON similarity score may be between (0.5, 1.0) if the keys of the output and the expected output pair match and some but not all of the values of the output and the expected output pair match. Continuing the example, the JSON similarity score may be 0.5 if the keys of the output and the expected output pair match but the values of the output and the expected output pair do not match. Continuing the example, the JSON similarity score may be between (0.0, 0.5) if some of the keys of the output and the expected output pair match. Continuing the example, the JSON similarity score may be 0.0 if no keys of the output and the expected output pair match. Alternatively, or additionally, in instances in which decoding associated with the JSON similarity scoring fails, no score may be returned which may indicate the failed decoding. In these and other instances, the evaluations as described herein may occur in different environments associated with the system 100. For example, the environments may include a localhost instance, a staging environment, a preproduction environment, and/or a production environment.

Modifications, additions, or omissions may be made to the system 100 without departing from the scope of the present disclosure. For example, each of the primitives 115 may include operations associated with an LLM that may individually correspond to a particular primitive. Alternatively, or additionally, an LLM may be operable to perform operations associated with more than one of the primitives 115, such that any number of LLMs may be utilized in the system 100. In another example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

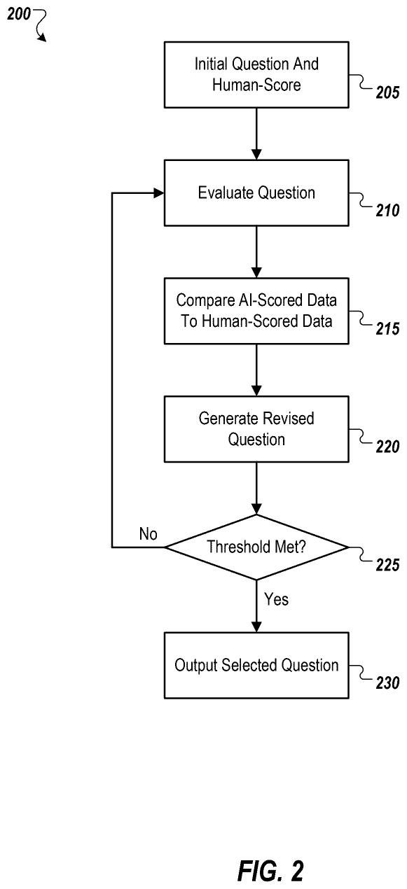

FIG. 2 illustrates a block diagram of an example flow 200 for evaluating and improving a question utilized in the system 100 of FIG. 1. The flow 200 may begin at block 205 where an initial question and/or human-score may be obtained. The human-score may be a scored for results associated with the initial question (e.g., an optimal score/result for the initial question).

At block 210, a judge LLM may obtain the initial question and may be operable to generate at least a judge score and/or a reasoning for the judge score associated with the initial question. The judge score may be based on the method described herein preparing a test question (as described) and then obtaining the judge score based on the test question.

At block 215, the judge LLM may compare the human-score with the judge score to determine a degree of accuracy for the judge score associated with the test question.

At block 220, based on the difference between the human-score and the judge score, the test question may be provided to an optimizer LLM. The optimizer LLM may be operable to analyze the test question, the human-score, and/or the judge score to determine one or more deficiencies in the test question and may develop an improved question in view of the analysis.

At block 225, the difference between the human-score and the judge score may be compared to a threshold to determine if the test question (and/or the improved question) may meet a predetermined threshold. In instances in which the threshold is not satisfied, the flow 200 may be rerun using the improved question as the initial question in the new run. In instances in which the threshold is satisfied, the flow may store the improved question as the best question.

At block 230, the best question may be output from the flow 200, and the judge LLM and/or the optimizer LLM may be individually trained to produce improved results in future flows. In some instances, the improvements may be obtaining better results, faster results (e.g., less iterations), and/or a combination of both.

Modifications, additions, or omissions may be made to the flow 200 without departing from the scope of the present disclosure. For example, in some instances, the order of the components in the flow 200 may be different than illustrated. For example, the threshold comparison in block 225 may be performed prior to the improved question of block 220 may be generated. In such instances, the improved question may not be generated when the threshold may be satisfied. In another example, the designations of different elements in the manner described is meant to help explain concepts described herein and is not limiting. Further, the flow 200 may include any number of other elements or may be implemented within other systems or contexts than those described. For example, any of the components of FIG. 2 may be divided into additional or combined into fewer components.

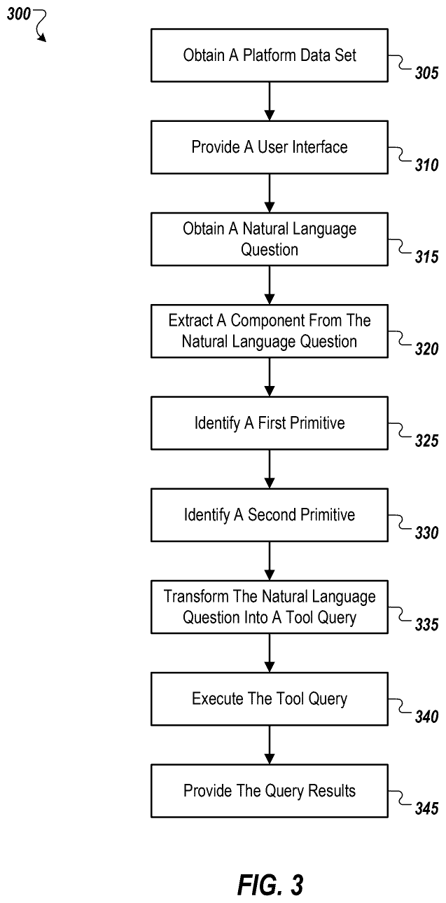

FIG. 3 illustrates a flowchart of an example method 300 for utilizing a large language model on platform data. The method 300 may be performed by processing logic that may include hardware (circuitry, dedicated logic, etc.), software (such as is run on a general purpose computer system or a dedicated machine), or a combination of both, which processing logic may be included in any computer system or device, such as the data platform 105 or the generative AI 125 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 305, a platform data set may be obtained. The platform data set may be obtained from one or more data providers. In some instances, the platform data set may be stored in a cleanroom.

At block 310, a user interface operable to interact with the platform data set may be provided. In some instances, the user interface may include one or more of a browser, an API, and/or a CLI.

At block 315, a natural language question may be obtained from the user interface. The natural language question may be operable to request a portion of the platform data set.

At block 320, at least one component may be extracted from the natural language question. In some instances, the at least one component may be a keyword or key phrase that may be included in the natural language question.

At block 325, a first primitive may be identified. The first primitive may be operable to transform the natural language question into a tool query. The tool query may be associated with a tool configured to obtain information from the platform data set. In some instances, the first primitive may be predefined based on the tool in which the first primitive may be used. In some instances, the tool may be one or more of a structured query language, an application programming interface, or a user defined table function.

At block 330, a second primitive may be identified. The second primitive may be operable to execute the tool query in the tool with respect to the platform data set. In some instances, the second primitive may be predefined based on the tool in which the second primitive may be used, which may be the same as the tool associated with the first primitive.

At block 335, the natural language question may be transformed into the tool query based on the at least one component using the first primitive.

At block 340, the tool query in the tool may be executed using the second primitive to obtain query results from the platform data set associated with the natural language question. In some instances, the query results may include a response criteria, an answer to the natural language question, and/or an analysis of the answer.

At block 345, the query results may be provided to the user interface in a natural language format.

Modifications, additions, or omissions may be made to the method 300 as described without departing from the scope of the present disclosure. For example, in some instances, the natural language question may be rewritten into a primitive-based query using the at least one component. The primitive-based query may be transformed into the tool query using the first primitive. Alternatively, or additionally, the primitive-based query may be rewritten based on the at least one component.

In another example, in some instances, the query results may be compared to the natural language question. An accuracy score may be determined based on the comparison. The accuracy score may be compared to a human generated score, where the human generated score may be determined by a human comparing the query results to the natural language question. In response to a difference between the accuracy score and the human generated score satisfying a threshold, the natural language question may be rewritten to obtain a revised natural language question. The revised natural language question may be utilized to be transformed into the tool query. In some instances, the accuracy score may be determined by one of a string match, a normalized string match, a Jaccard index, and/or semantic equivalency match between the query results and expected results for a particular input.

In another example, in some instances, the at least one component may be identified as invalid or missing. In response identifying the at least one component is invalid or missing, the at least one component may be replaced with a default component value. Further, the method 300 may include any number of other elements or may be implemented within other systems or contexts than those described.

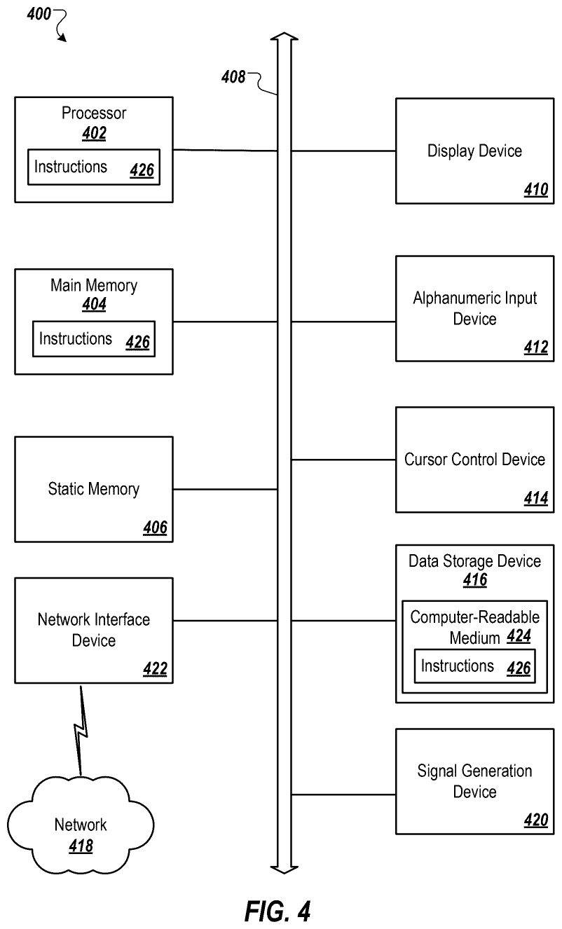

FIG. 4 illustrates an example computing device 400 within which a set of instructions for causing the machine to perform any one or more of the methods discussed herein may be executed. The computing device 400 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions for causing the machine to perform any one or more of the methods discussed herein may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 400 can include a processing device 402 (e.g., a processor), a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

The processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one implementation, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over the network 418 via the network interface device 422.

While the computer-readable storage medium 424 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining a platform data set;
providing a user interface operable to interact with the platform data set;
obtaining a natural language question from the user interface, the natural language question operable to request a portion of the platform data set;
extracting at least one component from the natural language question;
identifying a first primitive operable to transform the natural language question into a tool query associated with a tool configured to obtain information from the platform data set;
identifying a second primitive operable to execute the tool query in the tool with respect to the platform data set;
transforming the natural language question into the tool query based on the at least one component using the first primitive;
executing the tool query in the tool using the second primitive to obtain query results from the platform data set associated with the natural language question; and
providing the query results to the user interface in a natural language format.

2. The method of claim 1, further comprising:
rewriting the natural language question into a primitive-based query using the at least one component; and
transforming the primitive-based query into the tool query using the first primitive.

3. The method of claim 2, wherein the primitive-based query is rewritten based on the at least one component.

4. The method of claim 1, further comprising:
comparing the query results to the natural language question;
determining an accuracy score based on the comparison;
comparing the accuracy score to a human generated score;
in response to a difference between the accuracy score and the human generated score satisfying a threshold, rewriting the natural language question to obtain a revised natural language question; and
utilizing the revised natural language question to be transformed into the tool query.

5. The method of claim 4, wherein the accuracy score is determined by one of a string match, a normalized string match, a Jaccard index, and semantic equivalency match between the query results and expected results for a particular input.

6. The method of claim 1, further comprising identifying that the at least one component is invalid or missing.

7. The method of claim 6, wherein in response identifying the at least one component is invalid or missing, replacing the at least one component with a default component value.

8. The method of claim 1, wherein the first primitive and the second primitive are predefined based on the tool in which the first primitive and the second primitive are used.

9. The method of claim 1, wherein the query results comprise:
a response criteria;
an answer to the natural language question; and
an analysis of the answer.

10. The method of claim 1, wherein the tool is one or more of a structured query language, an application programming interface, or a user defined table function.

11. The method of claim 1, wherein the platform data set is stored in a cleanroom.

12. A system, comprising:
one or more non-transitory computer-readable storage media configured to store instructions; and
one or more processors communicatively coupled to the one or more non-transitory computer-readable storage media and configured to, in response to execution of the instructions, cause the system to perform operations, the operations comprising:
obtain a platform data set;
provide a user interface operable to interact with the platform data set;
obtain a natural language question from the user interface, the natural language question operable to request a portion of the platform data set;
extract at least one component from the natural language question;
identify a first primitive operable to transform the natural language question into a tool query associated with a tool configured to obtain information from the platform data set;
identify a second primitive operable to execute the tool query in the tool with respect to the platform data set;
transform the natural language question into the tool query based on the at least one component using the first primitive;
execute the tool query in the tool using the second primitive to obtain query results from the platform data set associated with the natural language question; and
provide the query results to the user interface in a natural language format.

13. The system of claim 12, wherein the operations further comprise:
rewrite the natural language question into a primitive-based query using the at least one component; and
transform the primitive-based query into the tool query using the first primitive.

14. The system of claim 13, wherein the primitive-based query is rewritten based on the at least one component.

15. The system of claim 12, wherein the operations further comprise:
compare the query results to the natural language question;
determine an accuracy score based on the comparison;
compare the accuracy score to a human generated score;
in response to a difference between the accuracy score and the human generated score satisfying a threshold, rewrite the natural language question to obtain a revised natural language question; and
utilize the revised natural language question to be transformed into the tool query.

16. The system of claim 15, wherein the accuracy score is determined by one of a string match, a normalized string match, a Jaccard index, and semantic equivalency match between the query results and expected results for a particular input.

17. The system of claim 12, wherein the operations further comprise identify that the at least one component is invalid or missing.

18. The system of claim 17, wherein in response identifying the at least one component is invalid or missing, replacing the at least one component with a default component value.

19. The system of claim 12, wherein the first primitive and the second primitive are predefined based on the tool in which the first primitive and the second primitive are used.

20. The system of claim 12, wherein the query results comprise:
a response criteria;
an answer to the natural language question; and
an analysis of the answer.
